(19) United States
(12) Patent Application Publication
(10) Pub. No.: US 2008/0291121 A1
(43) Pub. Date: Nov. 27, 2008

(54) DISPLAY FOR SONAR

(76) Inventor: Duane E. Cummings, Monticello, MN (US)

Correspondence Address: Thomas J. Nikolai Esq.;NIKOLAI & MERSEREAU, P.A., Suite 820, 900 Second Avenue South, Minneapolis, MN, 55402-3813, US

(21) Appl. No.: 11/753,800

(22) Filed: May 25, 2007

(51) Int. Cl. G09G 3/14; G01S 15/00

(52) U.S. Cl. 345/46; 367/107

(57) ABSTRACT

A low cost, low power consuming display for a solid state depth locator is provided. The display has no moving parts yet provides a real-time output indicative of the depth, size and density of targets in a body of water using colored LCDs.

### BACKGROUND OF THE INVENTION

### Field of the Invention

The present invention relates generally to solid state depth locators, sometimes referred to as “fish finders” used to determine the depth and size of fish and other objects in water. More specifically, the present invention relates to a low cost, low power consuming, color display for such a solid state depth locator that provides an easily understandable real-time indication of the depth and size (a.k.a. density) of objects located beneath the surface of the water.

Solid state depth locators have been known and used in the art for many years. See, for example, U.S. Pat. No. 5,459,479 entitled “Solid State Depth Locator Having Liquid Crystal Display” granted on Oct. 17, 1995 (to the same inventor here) which is incorporated by reference. Such depth locators typically have a transducer for transmitting sound waves through the water and detecting sound waves in the water. The transducer is typically operatively coupled to a controller via a transmitter and a receiver. Of course, those skilled in the art recognized that the transmitter and receiver can be combined as a single transceiver assembly. As used herein, “transmitter” and “receiver” refer either to separate assemblies or to the transmitter and receiver portions, respectively, of a transceiver.

In modern depth locators, the controller is typically a programmable microprocessor which operates in response to a programmable set of instructions and operator inputs. The controller controls the transmitter to deliver sound waves into the water via the transducer. As sound waves are reflected by objects in the water, they are detected by the transducer and transmitted via the receiver to the controller. The controller then processes the return signals to determine the depth of objects and their size. Size is also referred to in the art as density. Various filters and/or signal processing schemes can also be employed to eliminate or ignore sound waves detected by the transducer that are not returns of signals generated by the transducer.

Prior art depth locators generally had a user interface that permitted the controller to receive user inputs from the user and to convey information related to the depth and density of underwater objects to the user. The user interface typically included one or more switches coupled to the controller that enabled the user to indicate operating parameters to be used by the device. The user interface also included either a speaker to generate audible alerts or a visual display. U.S. Pat. No. 5,459,479 describes the use of liquid crystal displays, displays using neon bulbs and displays using light-emitting diodes. Cathode ray tubes have also been used. However, all prior art displays suffer from various problems.

Some displays draw too much power causing unacceptable drain on batteries used to power the device. This issue is particularly acute when the depth finder is powered by a self-contained battery such as when the device is used for ice fishing. Other problems relate to the brightness of the display and how ambient light can interfere with the ability of the user to read the display. Still other problems relate to the size and cost of the display. Other problems exist when displays are used that have motors, rotating bulbs and other moving parts. These displays are often not adequately reliable and are excessively noisy. As a cost-saving measure, many depth finders are equipped with grayscale displays. Yet it is difficult to distinguish between the shades of gray used to indicate the size of an object detected, particularly in locations where there is a lot of ambient light.

### SUMMARY OF THE INVENTION

The present invention seeks to overcome the foregoing disadvantages of prior art displays by providing a low cost, low power, color display with no moving parts, which is bright enough to see and read even on a sunny day in the middle of a lake even if the lake is frozen or covered with snow.

The display array of the present invention includes one or more alpha-numeric display elements. Such as, for example, seven segment liquid crystal display (LCD) elements. These are used to display either the parameters the user has set related to operation of the device and/or the scale used by the controller. The display array also includes a multicolored display element comprising a lens and a plurality of light-emitting diodes (LEDs) arranged in a configuration such as, for example, in the form of a bar, an arc, or circle. The LEDs are arranged in rows along the length of the configuration. In the simplest form, each row contains a single RGB (red, green, blue) LED which can be controlled so that it is illuminated to give off different colors. Alternatively, the rows comprise two or more single colored LEDs. The lens can be used to combine the colors provided by the illuminated LEDs to provide a greater number of colors than the number of LEDs in the row.

Both the LEDs and the LCD display element(s) are operationally coupled to the controller of the sonar detector either directly or via one or more drivers. When in use, the controller causes the LCD display element(s) to display, for example, a scale equating a depth of the body of water (or portion thereof) to the length of the LED display element. The controller also controls the illumination of the LEDs of the LED display element. One or more LEDs of a particular row are illuminated to provide an indication that there is an object in the water at the depth corresponding to the row. The color generated by the LEDs of a row illuminated by the controller indicates the density (a.k.a. size) of the object at that depth. In a display array of this type, power is conserved because only one LED is illuminated at a particular time. The controller turns the proper LEDs on and off at a rate such that the viewer perceives a solid color corresponding to the density of the object at the depth corresponding to the row.

Likewise, if multiple objects at different depths have been detected, the controller turns on and off the LEDs of the rows corresponding to the depths of the objects detected so that the viewer (1) perceives the rows corresponding to the depths of the objects as illuminated; and (2) perceives the color of each “illuminated” row as the color corresponding to the size/density of the object detected at the depth corresponding to the row.

### BRIEF DESCRIPTION OF THE DRAWINGS

FIG. 1 is a block diagram showing one preferred embodiment of the present invention.

FIG. 2 is a block diagram of a second preferred embodiment of the present invention.

FIG. 3 is a plan view of a display made in accordance with the present invention.

### DETAILED DESCRIPTION OF THE PREFERRED EMBODIMENT

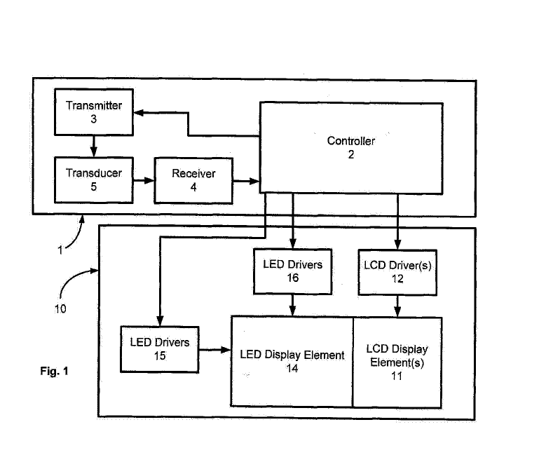

FIG. 1 is provided to show in general terms a sonar detector 1. As shown, the sonar detector 1 has a controller 2, a transmitter 3, a receiver 4 and a transducer 5. These are the basic building blocks of the sonar detector 1. In operation, the controller 2 instructs the transmitter 3 to transmit sound waves into the water via the transducer 5. The transducer 5 also detects sound waves in the water i.e., transmitted sound waves that have reflected off an object in the water back to the transducer 5. The transducer 5 passes these signals along to the controller 2 via the receiver 4 for processing by the controller 2. Those skilled in the art will understand that an actual sonar detector 1 made in accordance with the present invention will have components other than those shown including amplifiers, filters, analog-to-digital converters and the like. Likewise, those skilled in the art will recognize that a number of switches are also employed in a typical sonar detector to provide user inputs to the controller 2 even though none are shown in sonar detector 1 of FIG. 1.

The controller 2 can be any typical microprocessor-based controller with sufficient memory and ports to transmit control signals to the transducer 5 and the display array 10 and to process signals received via the transducer 5 and receiver 4 in accordance with a programmed set of instructions and user inputs related to operational parameters. More specifically, the controller 2 processes the signals to calculate the depth and density of an object and then sends output signals to a display array 10 to provide an indication of these calculated values.

A preferred embodiment of the display array of the present invention is also shown in FIG. 1. The display array 10 includes at least one LCD display element, each coupled to the controller 2 by an LCD display driver 12. The display array 10 also includes an LED display element 14. The LED display element 14 shown in FIG. 1 is coupled to the controller 2 by a pair of LED drivers 15 and 16.

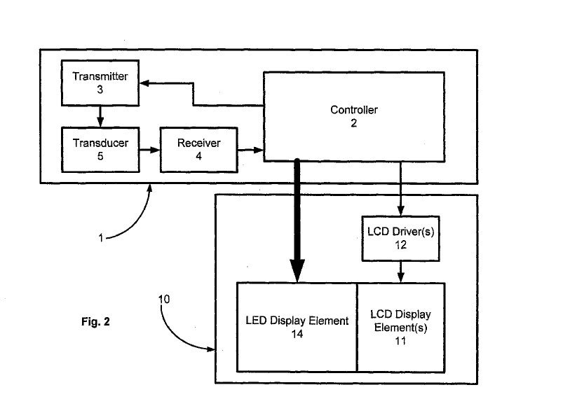

FIG. 2 shows an alternative embodiment. In this embodiment, the sonar detector 1 still includes a controller 2, a transmitter 3, a receiver 4, a transducer 5, an LCD display 11 and a LCD driver 12. However, while the embodiment of FIG. 2 still also includes an LED display element 14, the LED drivers shown in FIG. 1 have been eliminated and the function of these drivers is assumed by the controller 2. One skilled in the art should understand from the foregoing that the LCD driver 12 could likewise be eliminated and have its functionality also assumed by the controller 2.

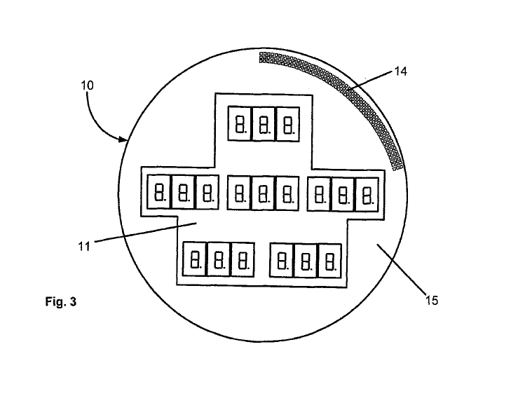

FIG. 3 is a schematic diagram showing the layout of a display array 10 made in accordance with the present invention. As shown, eighteen different seven-segment devices capable of displaying alpha-numeric characters are shown as comprising the LCD display element 11. Of course, other alpha-numeric display devices could be used instead of the LCD display devices. Also, a lesser number could be used by multiplexing the output to the display devices to provide the information to be conveyed by the LCD display element 11. The LCD display element 11 can be used to display operating parameters (e.g., modes) being used by the controller 2 in the operation of the sonar detector. The LCD display element 11 can also be used to display a scale associated with the LCD display element 14. This scale would obviously change based upon the depth of the water. Also, if the user wishes to zoom in on and only monitor objects in the water falling within a specific depth range, the user can do so and the LED display element reflects the selected range. For example, the overall depth of the water could be 150 feet, but the user may only be interested in objects within thirty feet of the surface. The LCD display element 11 can display the overall depth of the water and also the top and bottom of the range then displayed by LED element 14 as well as the scale of the LED element 14. Of course, to further reduce power consumption and when the foregoing features described with respect to the LCD display are not required, one or more scales can simply be painted or printed on the face of the display in proximity to the LED display element 14.

As shown in FIG. 3, the LED display element 14 has one hundred fifty LEDs arranged in three columns and fifty rows. All of the LEDs in a single column are preferably the same color. A separate color can be assigned to each column such that one column is red, another column is blue and a third column is yellow to provide a multicolor display. Given that there are fifty rows of LEDs in LED display element 14, the range covered by the LED display element 14 can be divided into up to fifty increments with each row representing an increment. One or more of the LEDs of a row can be illuminated by the controller if an object is detected in the water corresponding to that increment.

The advantage of an LED display element being multicolored is that different colors can be used to indicate the density of an object at a particular depth. Thus, the row of the LED(s) illuminated indicates the depth of the object and the color of the illumination indicates the density (i.e., size of the object).

In the embodiment shown in FIG. 3, each row of LED display element has a red, a blue and a yellow LED. Thus, these three LEDs can be separately illuminated to indicate detected objects falling in three separate density ranges. These LEDs can be illuminated in combination to indicate additional density ranges as suggested by Table I provided below:

| Density | | | Yellow | Perceived |
|---|---|---|---|---|
| Range | Red LED | Blue LED | LED | Color |
| 1 | On | Off | Off | Red |
| 2 | On | On | Off | Violet |
| 3 | On | Off | On | Orange |
| 4 | On | Off | On | Blue |
| 5 | Off | On | On | Green |
| 6 | Off | Off | On | Yellow |

It is important to note that a power saving technique of the present invention is to only illuminate a single LED at a time. Thus, to create other colors using the blue, red and yellow LEDs, the LEDs required to create a color are turned on and of in rapid succession so the desired color is perceived by the human eye. By adjusting the duration that the LEDs of a row are on and off, literally any color can be created using the three LEDs of a row. Some assistance is provided by a lens 15 covering the display in causing this mixing of colors.

Alternative techniques are, of course, available for providing the desired colors. For example, each row could comprise a single RGB type LED. Such an LED can be operated to give off red, green or blue light. An RGB LED can be turned in various ways to cause a viewer to perceive colors made by combining red, green and blue. Also, if only a small number of colors are necessary (e.g., two, three, four or five), the same number of individually colored columns can be provided so that each row has an LED of each required color.

Now that the basic structure of the device of the present invention has been described, several examples of its operation will be provided.

### EXAMPLE 1

In this example, the device of FIGS. 1-3 is operating in fifty feet of water, the user wants to monitor the entire depth and also monitor conditions below the bottom of the body of water. The user (or the controller) therefore selects from one of the available scales greater than 50 feet and displays the selected scale on the LCD display element. If the device detects an object 20 feet beneath the surface, one or more LEDs will be illuminated along the length of the LED array to indicate the depth and/or density of the object. Which of the LEDs of a particular row are illuminated will depend on the color to be displayed given the density of the object detected. Since the transducer will generate a 20 degree cone angle and bigger objects or objects having a markedly different density than the water will generally provide a larger return signal to the transducer, more than one row of LEDs can be illuminated when such objects are detected.

### EXAMPLE 2

In this example, the device of FIGS. 1-3 is operating in sixty feet of water, but the user has set the scale to monitor only the bottom ten feet of water. Thus, the LCD display element indicates the total depth of the water (60 feet) as well as the range reflected by LED display element 14 (i.e., 50 to 60 feet). If the sonar detector detects an object fifty-five feet down, one or more LEDs of row 25 will be illuminated. Which LEDs of row 25 (and perhaps other rows adjacent to row 25) are illuminated again depends on the density of the object detected.

### EXAMPLE 3

In this example, the sonar detector 1 is given the same settings as in Example 2. However, the device detects three objects in the water, one at sixty feet, another at thirty-five feet and a third at fifty feet. As in Example 2, the LCD display indicates the sixty foot total depth, and the range reflected by the LED display element 14 (i.e., 50 to 60 feet). Also, one or more LEDs in row 1 are illuminated to indicate the object at fifty feet, one or more LEDs in row 25 are illuminated to indicate the object at fifty-five feet, and one or more LEDs in row 50 are illuminated to indicate the object detected at sixty feet. By illuminating different colors in each of the three rows (or adjacent rows), the display can indicate the density/size of each of the three objects.

It is important to note that the normal state of each LED is off. Only a minimum number of LEDS are turned on at a time. When an LED is said to be illuminated, it is in fact sequentially pulsed with the other illuminated LEDs at a rate that allows a viewer to perceive illumination of the proper rows and colors. This scheme provides the desirable indicators and at the same time conserves power.

It is important to note that various modifications can be made to the LED display element 14 without deviating from the invention. Already mentioned are the ability to include a different number of LEDs in each row and the ability to use a single RGB LED in each row rather than individually colored LEDs. Also, while fifty rows of LEDs are discussed above, a larger number of rows can be provided for greater precision. Also, a lesser number of rows can be used if the precision afforded by five hundred rows is not required. Further, FIG. 3 shows the LED display element 14 as having an overall shape of an arc. Display element 14 could be a circle completely surrounding the round face of the display. It could also be in the form of a bar with the top of the LED display element 14 representing the top of the selected range and the bottom of the LED display element 14 reflecting the bottom of the selected range.

Just as the selected LEDs of LED display element 14 are pulsed on and off to save power, the LCD display element 11 can normally be off and only illuminated when the user needs to read data from the LCD display element II.

The present invention provides a solid state display with no moving parts that accurately reflects the depth and density of objects in the water. It does so virtually in real-time and in a manner that conserves power. The display of the present invention is highly reliable. The foregoing description is intended to meet the disclosure requirements of the patent laws, but is not intended to be limited. The scope of protection is limited only by the following claims.

What is claimed is:

1. For a solid state controller-based sonar detector for detecting the depth and density of targets in water, a display array comprising:
a. a multicolored display element comprising a lens and a plurality of colored light-emitting diodes arranged in rows along its length;
b. a driver element operatively coupled to said controller and said plurality of light-emitting diodes, wherein said driver in response to signals received from said controller selectively illuminates said plurality of light-emitted diodes such that the row of illuminated light-emitting diodes indicates the depth of detected targets and the color generated by illuminated light-emitting diodes of a row indicates the density of the target at the depth corresponding to the row.

2. The display array of claim 1 further including an alpha-numeric display element responsive to signals generated by a controller of said sonar detector to indicate at least one of a setting or a scale used by the controller.

3. The display array of claim 1 wherein at least one of said rows comprises a single RGB light-emitting diode.

4. The display array of claim 3 wherein said driver element cooperates with said RGB light-emitting diode to cause the RGB light-emitting diode to give off light of varying colors based upon signals received from the controller.

5. The display of claim 1 wherein at least one of said rows comprises a first light-emitting diode of a first color and a second light-emitting diode of a second color.

6. The display of claim 5 wherein when a target is detected at a position corresponding to said at least one of said rows only the first light-emitting diode illuminates if the density of said target falls within a first range, only the second light-emitting diode illuminates if the density of said target falls within a second range, and both the first and second light-emitting diodes illuminate if the density of the target falls within a third range.

7. The display of claim 6 wherein said lens combines the first and second colors when both of said first and second light-emitting diodes are illuminated to provide a third color.

8. The display of claim 1 wherein at least one of said rows comprises a first light-emitting diode of a first color, a second light-emitting diode of a second color, and a third light-emitting diode of a third color.

9. The display of claim 8 wherein when a target is detected at a position corresponding to said at least one of said rows, only the first light-emitting diode illuminates if the density of said target falls within a first range, only the second light-emitting diode illuminates if the density of said target galls within a second range, and only the third light-emitting diode illuminates if the density of said target falls within a third range.

10. The display of claim 9 wherein said first and second light-emitting diodes illuminate if the density of said target falls within a fourth range.

11. The display of claim 10 when said first and third light-emitting diodes illuminate if the density of said target falls within a fifth range.

12. The display of claim 11 wherein said second and third light-emitting diodes illuminate if the density of said target falls within a sixth range.

13. The display of claim 12 wherein said first, second and third light-emitting diodes illuminate if the density of said target falls within a seventh range.

14. The display of claim 1 wherein at least one of said rows has a plurality of different colored light-emitting diodes.

15. The display of claim 14 wherein when more than one of said plurality of different colored light-emitting diodes of a row are illuminated, said lens combines the colors to create a different color.

16. The display of claim 1 wherein said driver element includes at least two LED drivers.

17. For a solid state sonar detector for detecting the depth and density of targets in water, a display array comprising:
a. an alpha-numeric display responsive to signals generated by a controller of said sonar detector to indicate at least one of a setting or a scale used by the controller;
b. a multicolored display comprising a lens and a plurality of colored LEDs arranged in rows along its length responsive to signals generated by said controller, wherein said signals generated by said controller selectively illuminate said plurality of LEDs such that the row of the illuminated LEDs indicates the depth of the targets detected and the color generated by the illuminated LEDs of a row indicates the density of the target at the depth corresponding to the row.

18. A solid state detector for detecting the depth and density of targets in water comprising:
a. a controller;
b. a transmitter operatively coupled to said controller and a transducer such that the controller controls the delivery of sound waves into the water by the transducer;
c. a receiver operatively coupled to said controller and said transducer such that the controller receives signals representative of returns of said sound waves detected by said transducer and processes these signals to determine the depth and density of targets detected in the water;
d. a display array comprising (i) an alpha-numeric display responsive to signals generated by the controller to indicate at least one of a setting or a scale used by the controller; and (ii) a multicolored display comprising a lens and a plurality of colored LEDs arranged in rows along its length responsive to signals generated by said controller wherein said signals generated by said controller selectively illuminates said LEDs such that the row of illuminated LEDs indicates the depth of the targets detected and the color generated by the illuminated LEDs of a row indicates the density of the target at the depth corresponding to the row.
